(19) United States
(12) Patent Application Publication
(10) Pub. No.: US 2024/0399579 A1
(43) Pub. Date: Dec. 5, 2024

(54) DESIGN SYSTEM FOR ROBOTIC DEVICES

(71) Applicant: DISNEY ENTERPRISES, INC., Burbank, CA (US)

(72) Inventors: Moritz Niklaus Bächer, Zurich (CH); Christian Gabriel Schumacher, Aarau (CH); Lars Espen Knoop, Birmensdorf (CH); Guirec G.H.F. Maloisel, Zürich (CH); Ruben Jelle Grandia, Zürich (CH)

(21) Appl. No.: 18/669,623

(22) Filed: May 21, 2024

Related U.S. Application Data
(60) Provisional application No. 63/503,899, filed on May 23, 2023.

(51) Int. Cl. B25J 9/16

(52) U.S. Cl. CPC B25J 9/1671; B25J 9/1664

(57) ABSTRACT

A system for designing a robotic device, includes a processor configured to: receive a target animation for a character to be represented by the robotic device; receive an initial model of the robotic device, the model including a plurality of configurable joints and a plurality of actuators; generate a kinematic design of the robotic device based on the initial model and the target animation; generate control parameters for the plurality of actuators based on the kinematic design; generate a physical design for the robotic device based on the kinematic design and the control parameters; and deploy the physical design to the robotic device.

### CROSS-REFERENCE TO RELATED APPLICATIONS

This application claims the benefit of priority under 35 U.S.C. § 119 (e) and 37 C.F.R. § 1.78 to provisional application No. 63/503,899 filed on May 23, 2023, titled “Optimal Design of Robotic Character Kinematics” which is hereby incorporated by reference herein in its entirety.

### BACKGROUND

Creating robotic devices, such as animatronic characters, can be time intensive and processing intensive. Previous processes and systems for creating the physical linkages and joints of robotic devices are often slow, iterative and repetitive. For example, whether the creative vision for an animatronic character can be realized with a given set of robotic hardware is unknown at the outset. Furthermore, certain details of the hardware may also be unknown. Thus, many iterations of the robotic and character design may be needed to realize a functioning device. Therefore, there exists a need for improved processes and systems that can enable quick design of robotic systems.

### BRIEF SUMMARY

In one embodiment, a computer-implemented method for designing a robotic device, including a processor and a memory storing instructions that, when executed by the processor, cause the system to receive a target animation for a character to be represented by the robotic device; receive an initial model of the robotic device, the model including a plurality of configurable joints and a plurality of actuators; generate a kinematic design of the robotic device based on the initial model and the target animation; generate control parameters for the plurality of actuators based on the kinematic design; generate a physical design for the robotic device based on the kinematic design and the control parameters; and deploy the physical design to the robotic device.

Optionally, in some embodiments, the plurality of configurable joints include respective parameterized characteristics fixed during an animation of the robotic device.

Optionally, in some embodiments, the instructions, when executed by the processor cause the processor to parameterize a characteristic of at least one of the plurality of configurable joints.

Optionally, in some embodiments, the plurality of configurable joints includes at least one of a Cartesian joint, a prismatic joint, a cylindrical joint, a revolute joint, a universal joint, or a spherical joint.

Optionally, in some embodiments, the plurality of configurable joints includes at least one of an actuated joint or a passive joint.

Optionally, in some embodiments, the parameterized characteristics include at least one of an orientation or position of at least one of the plurality of configurable joints.

Optionally, in some embodiments, the instructions, when executed by the processor cause the processor to discretize the target animation into a plurality of time intervals.

Optionally, in some embodiments, the instructions, when executed by the processor cause the processor to compare a motion of the robotic device with respect to the target animation at each of the plurality of time intervals, and adjust the kinematic design based on the comparison.

Optionally, in some embodiments, the comparing the motion of the robotic device includes measuring at least one of a position of at least one of the plurality of actuators or a velocity of at least one of the plurality of actuators.

In one embodiment, a system for designing a robotic device, includes a processor configured to: receive a target animation for a character to be represented by the robotic device; receive an initial model of the robotic device, the model including a plurality of configurable joints and a plurality of actuators; generate a kinematic design of the robotic device based on the initial model and the target animation; generate control parameters for the plurality of actuators based on the kinematic design; generate a physical design for the robotic device based on the kinematic design and the control parameters; and deploy the physical design to the robotic device.

Optionally, in some embodiments, the plurality of configurable joints include respective parameterized characteristics fixed during an animation of the robotic device.

Optionally, in some embodiments, the processor is further configured to parameterize a characteristic of at least one of the plurality of configurable joints.

Optionally, in some embodiments, the plurality of configurable joints includes at least one of a Cartesian joint, a prismatic joint, a cylindrical joint, a revolute joint, a universal joint, or a spherical joint.

Optionally, in some embodiments, the plurality of configurable joints includes at least one of an actuated joint or a passive joint.

Optionally, in some embodiments, the parameterized characteristics of the plurality of configurable joints includes at least one of an orientation or position of at least one of the plurality of configurable joints.

Optionally, in some embodiments, the processor is further configured to discretize the target animation into a plurality of time intervals.

Optionally, in some embodiments, the processor is further configured to compare a motion of the robotic device with respect to the target animation at each of the plurality of time intervals, and adjust the kinematic design based on the comparison.

Optionally, in some embodiments, comparing the motion of the robotic device includes measuring at least one of a position of at least one of the plurality of actuators or a velocity of at least one of the plurality of actuators.

In one embodiment, a robotic device includes: a plurality of rigid bodies coupled together by one or more of a plurality of joints. At least one of the plurality of joints is configurable to adjust a characteristic of the joint, and the characteristic of the joint is fixed during an animation of the robotic device.

Optionally, in some embodiments, at least one of the plurality of joints includes an actuated joint or a passive joint.

### BRIEF DESCRIPTION OF THE DRAWINGS

FIG. 1 illustrates a design system for robotic devices.

FIG. 2A is a view of an example of a linkage in a first configuration.

FIG. 2B is a view of an example of the linkage of FIG. 2A in a second configuration.

FIG. 2C is a view of an example of the linkage of FIG. 2A in a third configuration.

FIG. 3A is a perspective view of an example of a joint of a robotic device in a first design configuration.

FIG. 3B is a perspective view of the joint of FIG. 3A in a second design configuration.

FIG. 4A is a perspective view of an example of a Cartesian joint.

FIG. 4B is a perspective view of an example of a prismatic joint.

FIG. 4C is a perspective view of an example of a cylindrical joint.

FIG. 4D is a perspective view of an example of a revolute joint.

FIG. 4E is a perspective view of an example of a universal joint.

FIG. 4F is a perspective view of an example of a spherical joint.

FIG. 5A is a perspective view of a portion of a robotic device.

FIG. 5B is a detail view of the portion of the robotic device of FIG. 5A in a first design configuration.

FIG. 5C is a detail view of the portion of the robotic device of FIG. 5A in a second design configuration.

FIG. 6 is a simplified block diagram of a method of designing a robotic system.

FIG. 7A is a perspective view of an animated character.

FIG. 7B is a perspective view of a robotic device configured to depict the animated character of FIG. 7A, in a first design configuration.

FIG. 7C is a perspective view of the robotic device of FIG. 7B, in a second design configuration.

FIG. 7D is a perspective view of the robotic device of FIG. 7B performing an animation of the animated character of FIG. 7A.

FIG. 8 is a simplified block diagram of components of a computing system of the system of FIG. 1 or any robotic device herein.

### DETAILED DESCRIPTION

The kinematic motion of a robotic device is defined by its mechanical joints and actuators that create the relative motion of its components. Kinematics describes degrees-of-freedom (“DOF”) of respective linkages, their positions, velocities, and ranges of motion. The disclosed systems and methods provide improvements in the kinematic design and control of robotic devices, allowing faster and easier deployment of different target motions to different or new robotic devices. In many embodiments, the system includes configurable joints that can be modified to change output characteristics thereof, enabling a rapid deployment of different types of desired movement.

In many embodiments, a method includes receiving a target animation for a character to be represented by the robotic device and based on the target animation, an initial robotic model (e.g., three-dimensional solid model) may be generated. The robotic model typically includes a plurality of rigid bodies or links joined by a variety of types of joints to form one or more linkages. The linkages are assembled together in a robotic device (either virtually and/or in physical reality). The joints may be actuated joints (e.g., powered joints that move under the power of a motor or the like) or passive joints (e.g., unpowered joints or followers), or configurable joints, which may be real or simulated joints, which can be changed to adapt the configuration of the robot. The configurable joints enable a robotic device assembly to be parameterized. By setting up a model of the robotic device with configurable joints, the configurable joints may modify the overall shape of the robotic device, the length and shape of robot links or solid bodies, the position and/or orientation of actuators, the position and/or orientation of passive joints, the mass distribution of the robot, and the like. In many embodiments, the configuration may be changed and/or set before starting an animation and then remains fixed during the animation. The configuration variation can be done virtually (e.g., to enable design of both the robotic devices and animation) and physically (e.g., to actually change the physical outputs of the robotic device and particular joints).

The system may parameterize one or more aspects of a configurable joint, such as one or more positions or angles. Parameterization of a robotic device's configurable joints provides the benefits of enabling rapid design iteration, a design optimization method that eliminates redundancy in constraints, and is therefore agnostic to the robot kinematics, and a reduction of the local approximate design-control to a discrete-time optimal control problem that enables efficient, scalable, and robust solving of the kinematic design using dynamic programming. The system utilizes the components (including those that are parameterized) to optimize the robotic device's kinematics with respect to the target animation. For example, the system may discretize the target animation at one or more points in time and compare position and orientation of the components at those times to the target animation, i.e., comparing the desired position and orientation of a given component with the actual position and orientation. In instances where components stray from the target animation, movements of those components may be restricted or de-weighted to assist in realigning the component to match the desired input. The system may generate and solve a constrained optimization problem to optimize the kinematic design.

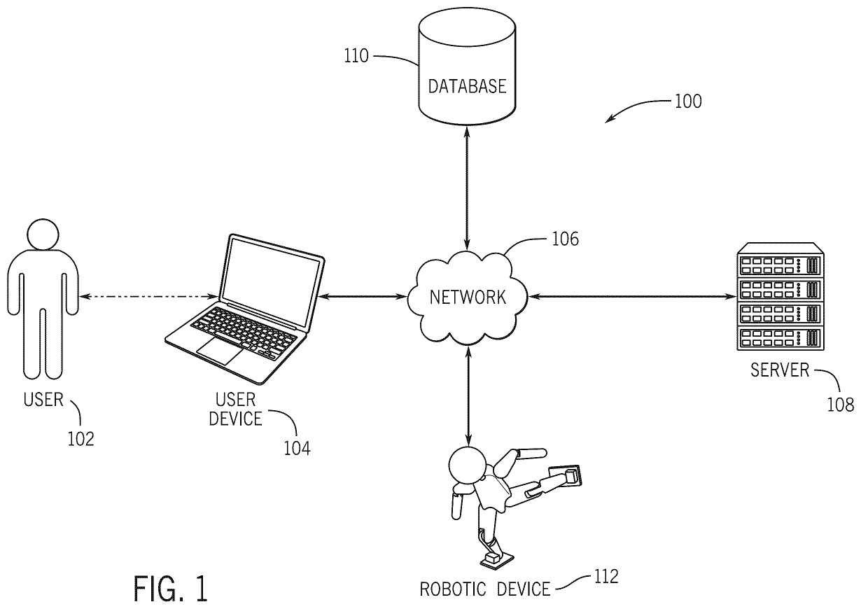

Turning to the figures, FIG. 1 shows an example of a system 100 suitable for optimizing the kinematic design of a robotic device 112. As shown for example in FIG. 1. the system 100 includes a user device 104, a server 108, a database 110, and a robotic device 112. The devices of the system 100 may be in communication with one another via a network 106.

The user device 104 may be a phone, tablet, laptop, desktop, or a virtualized environment on the server 108. The user device 104 may be suitable to simulate or model any aspect of a robotic device 112 herein, such as the type and number of any bodies, links, linkages, or actuators of a robotic device 112, as well as the kinematic performance of the resulting robotic device 112.

The database 110 may store models, simulations, or other data related to the kinematic design of any robotic device 112 disclosed. The database 110 may be in communication with the server 108 directly or via the network 106.

The server 108 is any computing device that can receive a user input and perform a calculation based on that input. In many embodiments, the server 108 may have more substantial computing, communications, and/or storage capacity than the user device 104. The server 108 may be a discrete computing device, a cloud computer instance, or any number of computing devices in communication with one another.

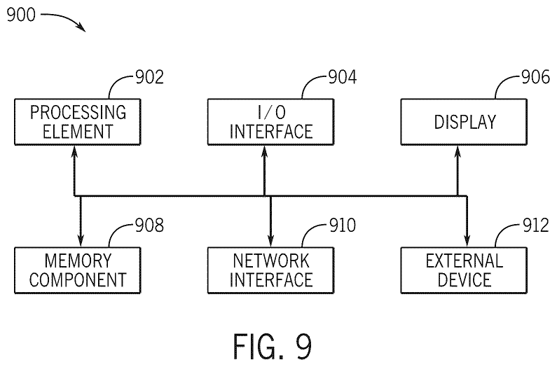

The network 106 may be implemented using one or more of various systems and protocols for communications between computing devices. In various embodiments, the network 106 or various portions of the network 106 may be implemented using the Internet, a local area network (LAN), a wide area network (WAN), and/or other networks. In addition to traditional data networking protocols, in some embodiments, data may be communicated according to protocols and/or standards including near field communication (NFC), Bluetooth, cellular connections, Wi-Fi, Zigbee, and the like. See FIG. 8 and related discussion for more detail on the components of the system 100.

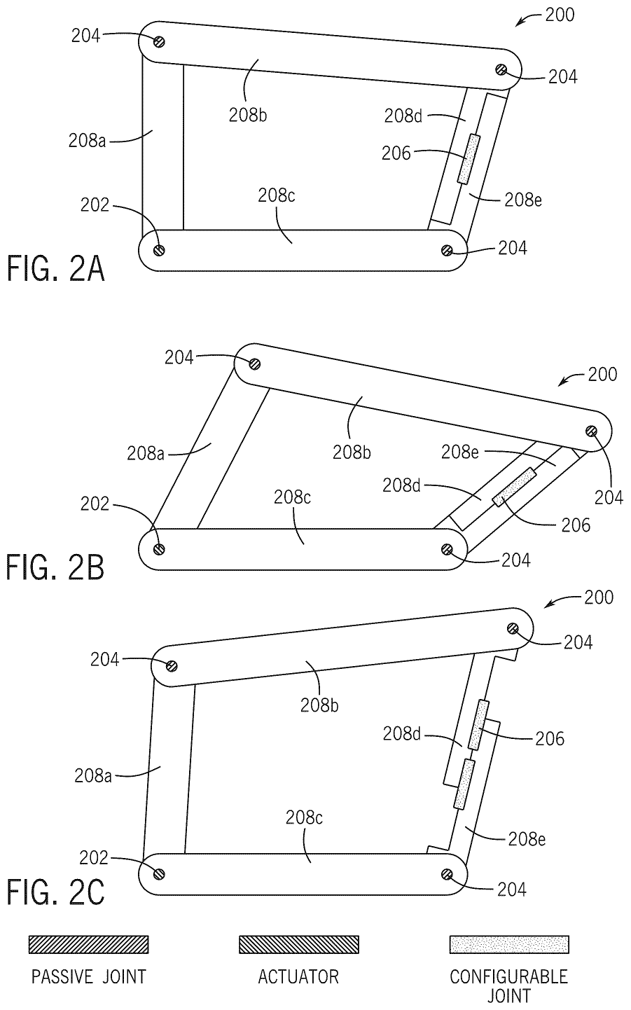

Turning to FIG. 2A-FIG. 2C, an example of a linkage 200 is shown in various configurations. The linkage 200 includes five solid bodies (also called links or rigid bodies): solid body 208a, solid body 208b, solid body 208c, solid body 208d, and solid body 208e. As will be explained, while there are five solid bodies, when animated or actuated, the linkage 200 acts as a four-bar linkage. While the example linkage 200 shown is a simple four-bar linkage, the teachings provided by this example are applicable to any linkage or robotic device 112 herein.

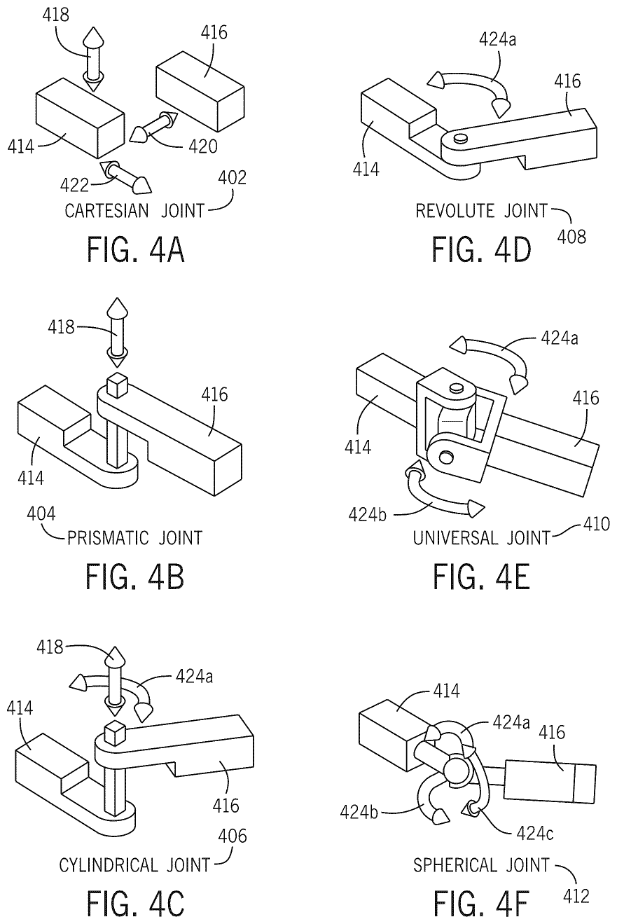

The solid bodies of the linkage 200 are coupled by a plurality of passive joints 204. In this example, many of the passive joints 204 are examples of revolute joints 408 (discussed in detail with respect to FIG. 4D). The passive joints 204 allow the solid bodies coupled thereby to pivot relative to one another. Depending on the relative lengths of the solid bodies, different motions can be performed by this example four-bar linkage.

As shown for example in FIG. 2A, one of the joints is an actuated joint 202 and is moveable by an actuator. As used herein, an actuator is any device that can impart motion to another component of a linkage or robotic device 112. For example, an actuator may be an electromagnetic device such as a motor, servo, power screw, solenoid, or a pneumatic/hydraulic device such as a hydraulic motor, piston, etc. As the actuated joint 202 moves, the physical constraints imparted by the passive joints 204, the actuated joint 202, and the solid bodies 208a-e cause the linkage 200 to move, e.g., a shown for example in the relative positions of the linkage 200 between FIG. 2A and FIG. 2B.

In the example of the linkage 200, one of the “bars” of the 4-bar linkage is comprised of two solid bodies 208d and 208e coupled to one another via a configurable joint 206. As used herein “configurable” refers to a joint whose state is changeable while a linkage or robotic device 112 is not in motion. For example, a position and/or, orientation of a configurable joint may be set at a certain value prior to exercising the linkage or robotic device 112. As used herein, “moveable” or the like refers to motion of a component, link, solid body, actuator, or robotic device 112 during an animation sequence thereof.

The configurable joint 206 is repositionable between animations of the linkage 200. In other words, the relative positions of the solid body 208d and solid body 208e are fixed during motion of the linkage 200, but may be re-positioned between motions of the linkage 200 to impart different kinematic characteristics to the linkage 200.

The example configurable joint 206 shown is an example of a Cartesian joint 402 (discussed in detail with respect to FIG. 4A). As shown for example in FIG. 2C, the configurable joint 206 can be configured such that the solid body 208d and the solid body 208c can be moved longitudinally (e.g., along their respective longitudinal axes) and the configurable joint 206 secured to prevent such relative longitudinal movement during an animation of the linkage 200. Thus, the configurable joint 206 provides the linkage 200 the ability to perform many different types of motion without redesigning or rebuilding the linkage 200. In the example linkage 200 shown, only one configurable joint 206 is used, but in other examples, two or more configurable joints 206, and/or configurable joints 206 of different types may be used. For example, any of the other “bars” of the four bar linkage may include a configurable joint 206 as shown (e.g., a Cartesian joint 402 or another type of joint). Also, any of the passive joints 204 or the actuated joint 202 may also be configurable.

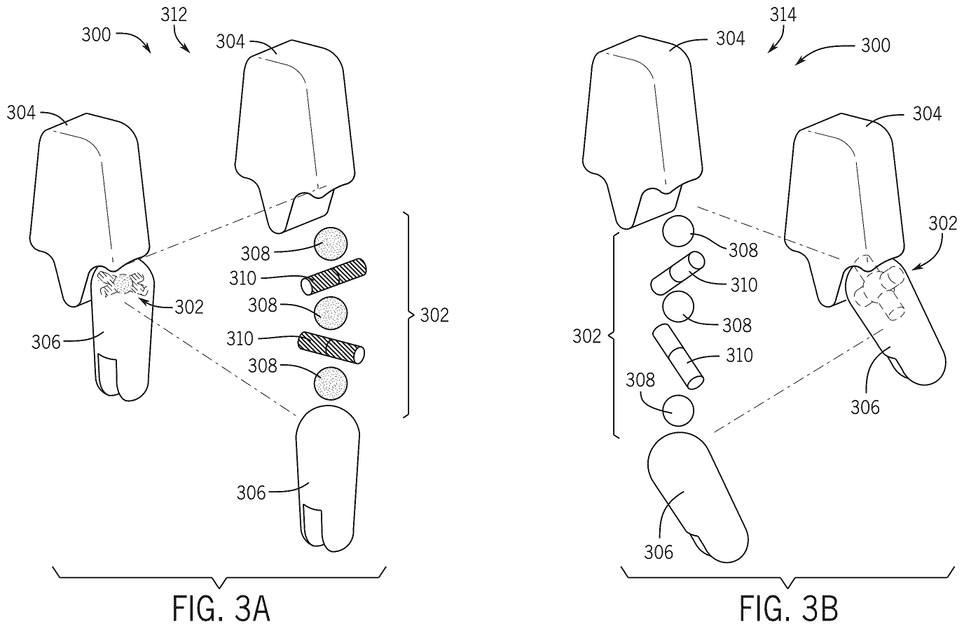

In some embodiments, the orientations, q_{A} and q_{B}, of two bodies (e.g., links or rigid bodies) A and B, may be set to the identity in the initial configuration, exemplified with a revolute joint, actuator, or configurable joint. See, e.g., FIG. 4A-FIG. 4F and related discussion for more detail on joint types. This convention may provide that the three frame axes, a_{y}, a_{y}, a_{z}, are the same in global and local body coordinates of a robotic device in its initial neutral pose (e.g., the initial design configuration 312 discussed with respect to FIG. 3), simplifying the formulation of constraints. In some embodiments, the global position of the frame, x, defines the positions, x_{A} and x_{B}, in local body coordinates. Joint, actuator, and configurable joint types may have varying translational and rotational degrees of freedom.

Joints, actuators, and configurable joints constrain the relative motion between pairs of components A and B, whose states may be represented with 7-vectors s_{A} and s_{B} that encode the components' positions, c_{A} and c_{B}, and their orientations, q_{A} and q_{B}, represented by quaternions. In some embodiments, the Euler-Rodrigues formula may be used to convert a unit-quaternion q to a rotation matrix R(q) and R(u,a) to represent a rotation by u about axis a. R_{A} and R_{B} abbreviate R(q_{A}) and R(q_{B}). For cylindrical and prismatic joints, the difference vector d=(R_{A}x_{A}+c_{A})−(R_{B}x_{B}+c_{B}) may be defined. The Cartesian actuator or configurable joint has three parameters, u, that determine the translations along the three axes, A=[a_{y},a_{y},a_{z}]. The spherical actuator or configurable joint is parameterized with a quaternion u whose length may be constrain to 1 during optimizations. The cylindrical and universal actuators or configurable joints are parameterized with two parameters, u₁ and u₂, and the prismatic and revolute actuators or configurable joints with a single parameter u. The fixed joint does not have a corresponding actuator or configurable joint, because it already removes all degrees of freedom. The ground joint keeps a single component fixed in space at its initial position c₀ (and orientation which is set to the identity). Vectors eₓ, e_{y}, and e_{z} are the three unit vectors.

TABLE 1

| | passive | active |
|---|---|---|
| Cartesian | (R_{A}aₓ) · (R_{B}a_{y}) | (R_{A}(x_{A} + Au) + c_{A}) − |
| | (R_{A}aₓ) · (R_{B}a_{z}) | (R_{B}x_{B} + c_{B}) |
| | (R_{A}a_{y}) · (R_{B}a_{z}) | (R_{A}aₓ) · (R_{B}a_{y}) |
| | | (R_{A}aₓ) · (R_{B}a_{z}) |
| | | (R_{A}a_{y}) · (R_{B}a_{z}) |
| spherical | (R_{A}x_{A} + c_{A}) − | (R_{A}x_{A} + c_{A}) − |
| | (R_{B}x_{B} + c_{B}) | (R_{B}x_{B} + c_{B}) |
| | | (R_{A}R(u)aₓ) · (R_{B}a_{y}) |
| | | (R_{A}R(u)aₓ) · (R_{B}a_{z}) |
| | | (R_{A}R(u)a_{y}) · (R_{B}a_{z}) |
| cylindrical | d · (R_{B}a_{y}) | (R_{A}(x_{A} + aₓu₁) + c_{A}) − |
| | d · (R_{B}a_{z}) | (R_{B}x_{B} + c_{B}) |
| | (R_{A}aₓ) · (R_{B}a_{y}) | (R_{A}aₓ) · (R_{B}a_{y}) |
| | (R_{A}aₓ) · (R_{B}a_{z}) | (R_{A}aₓ) · (R_{B}a_{z}) |
| | | (R_{A}R(u₂, aₓ)a_{y}) · (R_{B}a_{z}) |
| universal | (R_{A}x_{A} + c_{A}) − | (R_{A}x_{A} + c_{A}) − |
| | (R_{B}x_{B} + c_{B}) | (R_{B}x_{B} + c_{B}) |
| | (R_{A}aₓ) · (R_{B}a_{y}) | (R_{A}aₓ) · (R_{B}a_{y}) |
| | | (R_{A}R(u₁, aₓ)R |
| | | (u₂, a_{y})aₓ) · (R_{B}a_{z}) |
| | | (R_{A}R(u₁, aₓ) |
| | | R(u₂, a_{y})a_{y}) · (R_{B}a_{z}) |
| prismatic | d · (R_{B}a_{y}) | (R_{A}(x_{A} + aₓu) + c_{A}) − |
| | d · (R_{B}a_{z}) | (R_{B}x_{B} + c_{B}) |
| | (R_{A}aₓ) · (R_{B}a_{y}) | (R_{A}aₓ) · (R_{B}a_{y}) |
| | (R_{A}aₓ) · (R_{B}a_{z}) | (R_{A}aₓ) · (R_{B}a_{z}) |
| | (R_{A}a_{y}) · (R_{B}a_{z}) | (R_{A}a_{y}) · (R_{B}a_{z}) |
| revolute | (R_{A}x_{A} + c_{A}) − | (R_{A}x_{A} + c_{A}) − |
| | (R_{B}x_{B} + c_{B}) | (R_{B}x_{B} + c_{B}) |
| | (R_{A}aₓ) · (R_{B}a_{y}) | (R_{A}aₓ) · (R_{B}a_{y}) |
| | (R_{A}aₓ) · (R_{B}a_{z}) | (R_{A}aₓ) · (R_{B}a_{z}) |
| | | (R_{A}R(u, aₓ)a_{y} · (R_{B}a_{z}) |
| fixed | (R_{A}x_{A} + c_{A}) − | |
| | (R_{B}x_{B} + c_{B}) | |
| | (R_{A}aₓ) · (R_{B}a_{y}) | |
| | (R_{A}aₓ) · (R_{B}a_{z}) | |
| | (R_{A}a_{y}) · (R_{B}a_{z}) | |
| ground | c − c₀ | c − (c₀ + u₁) |
| | (Reₓ) · e_{y} | (Reₓ) · (R(u₂)e_{y}) |
| | (Reₓ) · e_{z} | (Reₓ) · (R(u₂)e_{z}) |
| | (Re_{y}) · e_{z} | (Re_{y}) · (R(u₂)e_{z}) |

Mechanical joints restrict the relative motion between pairs of bodies, A and B. To formulate constraints, one may define a frame whose global position, x, coincides with the position of the joint in the robotic device's initial pose, and whose axes aₓ, a_{y}, and a_{y} align with its degrees of freedom. Because initial orientations may be set to the identity, the local frame axes in the body coordinates of A and B equal the global axes, and the local frame positions are x_{A}=x−c_{A} and x_{B}=x−c_{B}. In some embodiments, constraints between pairs of components may be as summarized in summarized in Table. 1,

As discussed in more detail with respect to FIG. 4A-FIG. 4F, the system 100 supports many common joint types: Cartesian joints have three translational degrees of freedom, and spherical joints have three rotational degrees of freedom. Cylindrical joints and universal joints have two degrees of freedom, and prismatic and revolute joints have a single translational or rotational degree of freedom. A fixed joint locks the relative motion between a pair of components. A fixed joint is useful during design exploration, because it can be used to “freeze” degrees of freedom between components, without having to merge them. To prevent a robotic device from moving in space, a ground joint may be used which keeps a single component in its initial position and orientation.

The mechanical joints may also have constraints for a corresponding actuator. Passive constraints may be complemented with additional constraints, parameterizing the constraints with time-varying control parameters u (see, e.g., Table. 1). As values are determined for u, the relative states of the two components that they connect are determined. Revolute or prismatic actuators and spherical actuators can be used.

To parameterize a robotic device's kinematics a configurable joint may be used. A configurable joint may be similar to an actuator, but parameterized with design parameters p that remain the same throughout an animation, and may not typically vary with time like control parameters do (Table. 1, Configurable Joints, u replaced with p).

Given an initial design of a robotic device in its rest configuration, a set of constrains may be applied, as shown for example in Table 1,

$$C ( p , u , s ) = 0 \qquad ( Eq . 1 )$$

that represents, together with the state of the components, the kinematics of the robotic device. The above constraints include a unit length constraint, q·q−1=0, for each component of the robotic device. Given a set of design and control parameters, this set of constraints can be used by the system 100 to solve for the state of the robotic device, s(p,u), and therefore to simulate its kinematic motion.

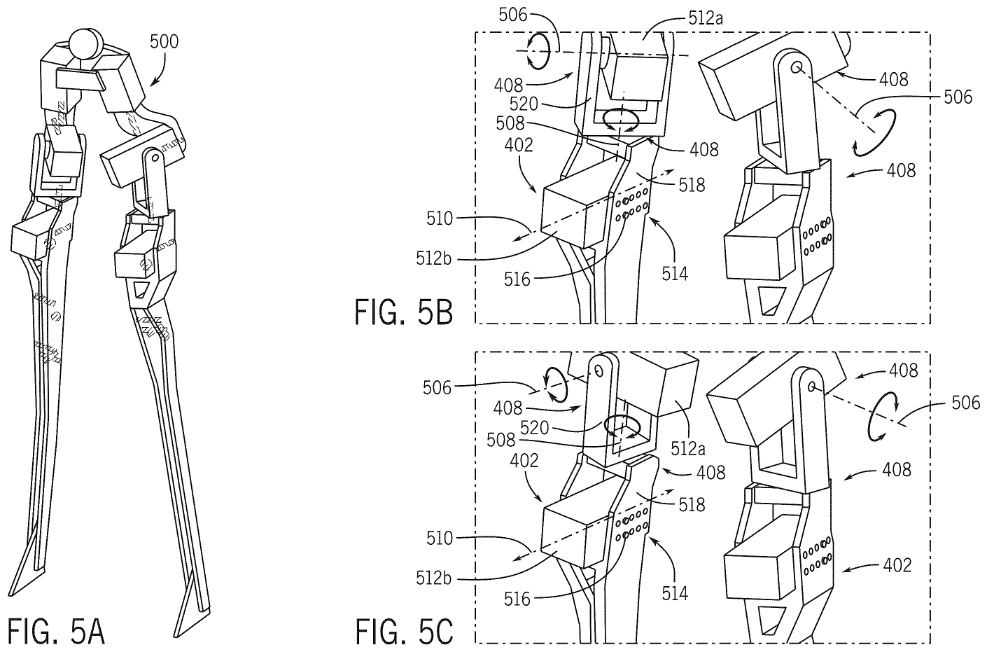

FIG. 3A continues the concepts disclosed in FIG. 2A-FIG. 2C with a more complex linkage 300. The linkage 300 comprises a hip joint 302, such as may be suitable for a robotic device 112. The hip joint 302 includes a torso 304, an upper leg portion 306, one or more configurable joints 308, and one or more actuated joints 310. As shown for example in FIG. 3A and FIG. 3B, the linkage 300 is an example of a virtual model of the linkage 300. However, the examples of FIG. 3A and FIG. 3B may be either virtual (e.g., computer generated solid models) or actual, physical components. The configurable joints 308 and/or the actuated joints 310 may be virtually configurable or actually, physically configurable (e.g., as shown and described with respect to FIG. 5A-FIG. 5C).

FIG. 3A shows the example linkage 300 in an initial design configuration 312. The initial design configuration 312 may be a first pass at a hip joint 302 that can perform a desired motion (e.g., walking). The actuated joints 310 may move the upper leg portion 306 medially or laterally with respect to the torso 304. Additionally, or alternately, the actuated joints 310 may move the upper leg portion 306 anteriorly or posteriorly with respect to the torso 304. The actuated joints 310 may move the upper leg portion 306 in combinations of these axes.

The configurable joints 308 may follow the motion imparted by the actuated joints 310. As shown for example in FIG. 3A and FIG. 3B, configurable joints 308 are examples of spherical joints 412 described in more detail with respect to FIG. 4F.

As described in more detail with respect to the method 600, the design configuration of a joint, such as the hip joint 302 may be optimized to perform a desired motion. See, e.g., FIG. 3B showing an example of an optimized design configuration 314. For example, any of the configurable joints 308 or the actuated joints 310 may have one or more aspects of their arrangement with the hip joint 302, their ranges of motion, their relative alignment, etc. changed to better enable the hip joint 302 to perform the desired motion. As shown for example in FIG. 3B, the orientation of the hip joint 302 has been aligned with the longitudinal axis and lateral axis of the upper leg portion 306 by re-orienting the actuated joints 310 of the hip joint 302 with respect to the initial design configuration 312.

With reference to FIG. 4A-FIG. 4F, various examples of joints suitable for use in a linkage or robotic device 112 are disclosed. These figures do not represent an exhaustive list of possible joints and are merely representative of illustrative options. The example joints are discussed with respect to sample axes (e.g., the axis 418, axis 420, axis 422) and angular directions (e.g., the angular direction 424a, angular direction 424b, and/or angular direction 424c). Other directions and axes, and combinations thereof, are contemplated within the scope of this disclosure. Any of the joints discussed herein may be passive joints 204 or actuated joint 310.

FIG. 4A shows an example of a Cartesian joint 402, which may be useful when two or more solid bodies (e.g., solid body 414 and/or solid body 416) are desired to slide with respect to one another. For example, the solid body 414 and solid body 416 may be moveable or configurable along one or more axes with respect to one another. As shown for example in FIG. 4A, the solid body 414 may be moveable or configurable along an axis 418, an axis 420, and/or an axis 422 with respect to the solid body 416. In some embodiments, the axis 418, axis 420, and axis 422 are mutually orthogonal axes. In some embodiments, the axis 418, axis 420, and/or 422 are disposed at another angle than 90° with respect to one another. The motion of the Cartesian joint 402 may also be constrained along a plane defined by any two of the axis 418, axis 420 and/or axis 422. For example, the motion of the Cartesian joint 402 may be constrained along a plane defined by the axis 418 and the axis 420, the axis 418 and the axis 422, or the axis 420 and the axis 422.

FIG. 4B shows an example of a prismatic joint 404. A prismatic joint 404 may be useful when it is desired to constrain a joint to be moveable or configurable along a single degree of freedom. As shown for example in FIG. 4B, the solid body 414 and the solid body 416 are moveable or configurable along the axis 418 but are constrained against movement in the axis 420 or axis 422. In other examples, the solid body 414 and axis 418 may be moveable or configurable along another one of the axis 418, the axis 420, or the axis 422 and constrained against movement along the other two of the axis 418, the axis 420, or the axis 422.

FIG. 4C illustrates an example of a cylindrical joint 406. A cylindrical joint 406 may be useful when linear motion between two solid bodies is desired to be constrained along an axis (similar to a prismatic joint 404) but also allowing rotational motion or configuration about that axis. As shown for example in FIG. 4C, the solid body 416 is moveable or configurable along an axis 418 and is also moveable or configurable rotationally in an angular direction 424a about the axis 418.

FIG. 4D illustrates example of a revolute joint 408. A revolute joint 408 may be useful when (as in the example linkage 200) the motion or configuration of two linked solid bodies is desired to be constrained along an angular direction 424a. For example the solid body 414 and the solid body 416 are moveable or configurable relative to one another along the angular direction 424a.

FIG. 4E shows an example of a universal joint 410, which may be useful when rotational motion along a longitudinal axis of a first solid body is desired to be imparted to a second solid body along the second body's longitudinal axis and there may be an angular misalignment between the two longitudinal axes. As shown for example in FIG. 4E, the solid body 414 longitudinal axis may be at an angle with respect to the longitudinal axis of the solid body 416. either or both of the solid body 414 or the solid body 416 may rotate or spin or be configurable about their respective longitudinal axes (e.g., in directions angular direction 424a and/or angular direction 424b).

FIG. 4F shows an example of a spherical joint 412, which may be useful when a wide range of freedom of movement or configuration is desired (as in the example of the linkage 300). As shown for example in FIG. 4F, the solid body 414 and the solid body 416 may be moveable about one or more of an angular direction 424a, an angular direction 424b, and/or an angular direction 424c.

Turning to FIG. 5A-FIG. 5C, an example of a leg linkage 500 is shown. The leg linkages 500 may be utilized for various legs or other supports for the robotic device, e.g., left and right legs. It should be noted that the leg linkage 500 will be discussed with respect to one of the legs, with the understanding that the discussion is applicable to the other leg as well, as such the discussion of any particular side, such as left or right, is meant as illustrative only. The leg linkage 500 includes a plurality of joints and actuators and may be suitable for a walking robotic device 112. In some examples the leg linkage 500 may have a different number and/or type of joints and/or actuators than shown in FIG. 5A-FIG. 5C.

As shown for example in FIG. 5A-FIG. 5C, the leg linkage 500 includes a lower leg portion 518 and an upper leg portion 520. The lower leg portion 518 and the upper leg portion 520 are coupled to one another by a revolute joint 408. An actuator 512a is coupled to the upper leg portion 520 by another revolute joint 408. An actuator 512b is coupled to the lower leg portion 518 by a Cartesian joint 402. Either or both of the revolute joints 408 or the Cartesian joint 402 may be configurable joints. For example, the actuator 512a is configurable by rotating the actuator 512a about an axis 506 of the revolute joint 408 at which the upper leg portion 520 and the actuator 512a are coupled. Similarly, the relationship of the upper leg portion 520 to the lower leg portion 518 may be configurable by rotating the upper leg portion 520 and lower leg portion 518 with respect to one another about the axis 508 by which they are coupled.

The actuator 512b is coupled to the lower leg portion 518 by one or more fasteners 516 received in apertures 514 of the lower leg portion 518 and corresponding apertures 514 of the actuator 512b. The actuator 512b may be configurable along one or more axes such as the axis 510. For example to configure the actuator 512b, the fasteners 516 may be removed, the actuator 512b repositioned with respect to the lower leg portion 518 and the fasteners 516 re-attached to couple the actuator 512b to the lower leg portion 518.

FIG. 5B shows the leg linkage 500 in an initial design configuration 502. The initial design configuration 502 may be a starting place for designing the leg linkage 500 to perform a desired motion. Using the methods disclosed, such as the method 600, the leg linkage 500 may be optimized to perform the desired motion by the system 100. The system 100 may output an optimized design configuration 504 (shown for example in FIG. 5C) for the leg linkage 500, that enables the leg linkage 500 to better perform the desired motion than the initial design configuration 502. For example, in the optimized design configuration 504, the actuator 512a may be revolved about the axis 506 with respect to the upper leg portion 520 to better enable the leg linkage 500 to perform the desired animation. Similarly, the rotational configuration of the upper leg portion 520 and the lower leg portion 518 with respect to one another may be changed between the initial design configuration 502 and the optimized design configuration 504. Other links, joints, and/or actuators of the leg linkage 500 may also be configured between the initial design configuration 502 and the optimized design configuration 504.

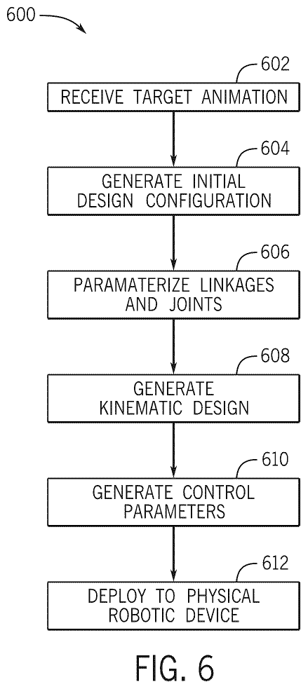

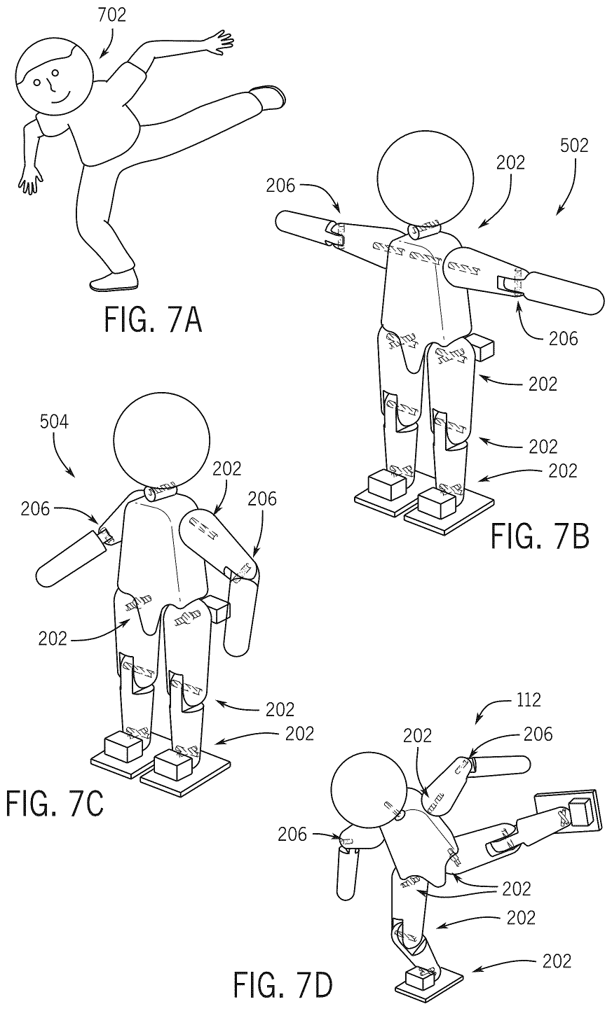

FIG. 6 illustrates an example method 600 for generating a kinematic design of a robotic device 112. Reference is also made to FIG. 7A-FIG. 7D in discussing the method 600. Although the example method depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, the method 600 includes receiving a target animation at operation 602. The target animation may be generated by an animation software, solid modeling software, sketch, or the like and is configured to provide a desired movement or sets of movements (e.g., choreographed) for a robotic device. See, e.g., FIG. 7A showing an example target animation 702 for an animated character performing a kicking motion. The target animation 702 may be created with or without consideration of the underlying kinematics of a robotic device 112 needed to perform the target animation 702 in real, physical space. For example, the target animation may be determined based on a creative input that may not necessarily include information or constraints of the actual physical system. The target animation 702 may be received by a processing clement 802, such as a processing element 802 of the user device 104 and/or server 108.

According to some examples, the method 600 includes generating an initial design configuration 502 at operation 604. For example, a processing element 802 may analyze the target animation 702 and determine the initial placement, type, number, and configuration of one or more components of a linkage capable of performing the target animation 702. For example, the system 100, or a user using the system 100, may place actuators and/or joints in naïve locations, amounts, and/or orientations with respect to the target animation 702, to form an initial design configuration 502. See, e.g., FIG. 7B showing an initial design configuration 502 with naïve placement of joints and actuators. The linkage may be placed in an initial design configuration 502 where the orientations, ranges of motion, or numbers of actuators, joints, and links is not known. As shown for example in FIG. 7B, the robotic device 112 may be placed in an initial design configuration 502 where the robotic device 112 includes one or more configurable joints 206, non-configurable joints, actuated joints 202, and/or passive joints.

According to some examples, the method 600 includes parameterizing the configurable joints of the robotic device 112 at operation 606. Parameterization typically includes selecting the properties of configurable joints included in the initial design configuration 502.

According to some examples, the method 600 includes generating the kinematic design of the robotic device 112 at operation 608. In one example, the system 100 discretizes the animation of the robotic device 112 based on the initial design configuration into multiple time steps and solves a constrained optimization problem of the robotic device's state at each time step. The motion of the device is compared to the target animation 702 at each time step, and parameters that result in close tracking of the target animation are emphasized while those that result in poor tracking are penalized. In some examples, to solve the constrained optimization problem, the system 100 solves for the state at a previous time step by minimizing an objective function of the robotic device 112's state for the current time step and control variables for the previous time step. E.g., the system 100 may solve backward in time, beginning at an end state for the target animation and proceeding backward to an initial animation state. Sec, e.g., Table 3.

According to some examples, the method 600 includes generating control parameters for the actuators at of the robotic device 112 at operation 610. The control parameters are configured to command the actuators of the robotic device to perform the target animation. The control parameters may be time-variant (e.g., at each discretized time step of the target animation) position, velocity, and/or acceleration commands for any actuator in the robotic device 112 given by a processor for the robotic device 112 to execute. The control parameters may be generated for either a simulated or real robotic device 112 based on the kinematic design and/or the initial design configuration, including the one or more configurable joints. In some examples, the operations 608 and 610 solving for the kinematic design and the control parameters respectively may be performed substantially simultaneously. In various examples, the operations 608 and 610 may be performed in one or more calculation loops, at discretized time intervals, or sequentially.

According to some examples, the method 600 includes deploying a kinematic design from the operation 608 to a physical robotic device at operation 612. For example the desired configurations of the configurable joints may be outputted by the system 100 (e.g., to a display, printout, solid model, or the like). The joints of the physical robot can be configured as determined in the method 600 such that the robotic device 112's performance of the motion closely tracks that of the target animation.

In some embodiments, a robotic device includes of a set of rigid components whose time-varying states are represented with 7D vectors that encode positions c and orientations q. For orientations, quaternions may be used and their unit length enforced with constraints of the form q·q=1. Variable s refers to the full state of the robotic device. Without loss of generality, in some embodiments, all orientations are set to the identity in the character's initial or rest pose.

In some embodiments, it is desired to optimize a character's parameterized joints to achieve a target animation 702 as closely as possible. Because optimal control parameters change if adjustments are made to design parameters, the variables of the optimization may be solved for simultaneously.

A design parameter change may have an impact on the entire motion of a robotic device, and therefore the system 100 may measure the performance of a particular design for an entire animation to make an optimal choice.

In some embodiments, of the operation 606, the system 100 discretizes the target motion into n time intervals Δt and k=0, . . . , n time steps, and introduce intermediate objectives, f, that measure the robotic device's performance with respect to the target animation 702 and ensure that actuator positions and velocities remain within limits. To directly penalize actuator velocities near limits, the system 100 may introduce time-varying velocity variables v and set them to \dot{u}. The system 100 may also introduce a terminal objective F that measures the difference between the robotic device's terminal state and its user-specified target.

To minimize the number of optimization variables, the system 100 may work with a single set of design parameters p. However, this choice results in a Hessian of the Lagrangian which is no longer a banded matrix due to sparsity along the time dimension. In addition, it would prevent the system 100 from applying a fast solution strategy based on dynamic programming, possibly requiring a recursive structure and local dependence between consecutive variables. The system 100 therefore may work with per-time-step design parameters pₖ, and enforce equality between them with constraints pₖ₊₁=pₖ.

To ensure that orientations in the design and control parameterization are singularity-free, the system 100 may use quaternions as control and design parameters for spherical and ground actuators and configurable joints (see, e.g., Table. 1). To enforce their unit length, the system 100 may add constraints, [symbol] (p₀)=0 and [symbol] (uₖ)=0, to the set of constraints. Because the system 100 enforces equality between design parameters, the system 100 may only enforce their unit lengths at k=0.

In one embodiment, a discrete-time optimal design problem is:

$${min}_{{p}_{k} , {u}_{k} , {v}_{k} , {s}_{k}} {\sum }_{k = 0}^{n - 1} f ( {p}_{k} , {u}_{k} , {v}_{k} , {s}_{k} ) + F ( {p}_{n} , {u}_{n} , {s}_{n} ) \qquad ( Eq . 2 )$$

$$s . t . {p}_{k + 1} - {p}_{k} = 0 ,$$

$$k = 0 , … , n - 1$$

$$\frac{{u}_{k + 1} - {u}_{k}}{Δ t} - {v}_{k} = 0 ,$$

$$k = 0 , … , n - 1$$

$$𝒫 ( {p}_{0} ) = 0$$

$$𝒰 ( {u}_{k} ) = 0 ,$$

$$k = 0 , … , n$$

$$𝒞 ( {p}_{k} , {u}_{k} , {s}_{k} ) = 0 ,$$

$$k = 0 , … , n .$$

According to some examples, the method includes optimizing kinematics of a robotic device 112 at operation 608 and/or generating control parameters at operation 610. A processing element 802 of the system 100 may output an optimized design configuration 504 for the robotic device 112, As shown for example in FIG. 7C. The optimized design configuration 504 may re-orient one or more links, solid bodies, joints, and/or actuators.

In some embodiments, the optimal design problem may be difficult to solve: It has a design and control parameter set per time step, and the constraints [symbol] , [symbol] , and [symbol] , as also the intermediate and terminal objectives, are nonlinear. As such, the system 100 may employ a variety of solution strategies in the operation 608.

In some embodiments, a first solution strategy may be sensitivity analysis where the system 100 solves for optimal states for a given set of design and control parameters in the inner loop, and then for optimal design and control parameters in the outer loop, with a first-order optimality constraint on the inner-loop optimization.

In some embodiments, an alternative solution strategy is sequential quadratic programming (SQP). To this end, the system 100 may introduce Lagrange multipliers [symbol] , [symbol] , [symbol] , [symbol] , and [symbol] for the five constraint sets and use λ to refer to the combined set of multipliers ( [symbol] : design constraints; [symbol] : velocity constraints). The Lagrangian may be represented by:

$${\sum }_{k = 0}^{n - 1} {ℒ}^{k} ( {p}_{k} , {u}_{k} , {v}_{k} , {s}_{k} , λ ) + {ℒ}^{n} ( {p}_{n} , {u}_{n} , {s}_{n} , λ ) , \qquad ( Eq . 3 )$$

that is partially separable because the design and velocity constraints, that depend on two consecutive time steps, are linear and can therefore be split into two parts.

To perform line search, the system 100 may compute search directions

$${d}_{k} = [ \begin{matrix}Δ {p}_{k} \\ Δ {u}_{k} \\ Δ {v}_{k} \\ Δ {s}_{k}\end{matrix} ] \qquad ( Eq . 4 )$$

$$for$$

$$k = 0 , … , n - 1$$

$$and$$

$${d}_{k} = [ \begin{matrix}Δ {p}_{k} \\ Δ {u}_{k} \\ Δ {s}_{k}\end{matrix} ]$$

$$for$$

$$k = n .$$

by either applying Newton to the Karush-Kuhn-Tucker conditions, or by solving the equivalent quadratic program (QP)

$${min}_{{d}_{k}} {\sum }_{k = 0}^{n} ∇ {ℒ}^{k} {d}_{k} + \frac{1}{2} {d}_{k}^{T} {∇}^{2} {ℒ}^{k} {d}_{k} \qquad ( Eq . 5 )$$

$$s . t . {p}_{k + 1} - {p}_{k} + Δ {p}_{k + 1} - Δ {p}_{k} = 0 ,$$

$$k = 0 , … , n - 1$$

$$\frac{{u}_{k + 1} - {u}_{k}}{Δ t} - {v}_{k} + \frac{Δ {u}_{k + 1} - Δ {u}_{k}}{Δ t} - Δ {v}_{k} = 0 ,$$

$$k = 0 , … , n - 1$$

$${𝒫}^{0} + {𝒫}_{p}^{0} Δ {p}_{0} = 0$$

$${𝒰}^{k} + {𝒰}_{u}^{k} Δ {u}_{k} = 0 ,$$

$$k = 0 , … , n$$

$${𝒞}^{k} + {𝒞}_{p}^{k} Δ {p}_{k} + {𝒞}_{u}^{k} Δ {u}_{k} + {𝒞}_{s}^{k} Δ {s}_{k} = 0$$

$$k = 0 , … , n ,$$

where the system 100 omits arguments for the last three sets of constraints, adding the time step as superscript instead. [symbol] ₚ, [symbol] ᵤ, [symbol] ₚ, [symbol] ᵤ, and [symbol] ₛ are constraint Jacobians with respect to design, control, and state variables.

To iteratively find optimal values for these variables, the system 100 may perform line search with the L1 merit function to identify a good step length α, and update the currently best estimates

$$[ \begin{matrix}{p}_{k} \\ {u}_{k} \\ {v}_{k} \\ {s}_{k}\end{matrix} ] := [ \begin{matrix}{p}_{k} \\ {u}_{k} \\ {v}_{k} \\ {s}_{k}\end{matrix} ] + α {d}_{k} \qquad ( Eq . 6 )$$

$$and$$

$$[ \begin{matrix}{p}_{n} \\ {u}_{n} \\ {s}_{n}\end{matrix} ] := [ \begin{matrix}{p}_{n} \\ {u}_{n} \\ {s}_{n}\end{matrix} ] + α {d}_{n} .$$

The system 100 may also update Lagrange multipliers. To do so, the system 100 may compute an increment Δλ, multiply it with the step length, and use it to update the current best estimate λ as explained towards the end of the section.

In some embodiments, the system 100 may compute the search directions for variables and multipliers to solve the QP by applying a direct sparse linear solver to the equivalent system of linear equations. For large problems, this strategy is limited by its computational cost and the memory that is necessary to assemble the system matrix.

Iterative solvers can circumvent the memory bottleneck by using access to a matrix-vector product operator, and can often be parallelized. However, a careful tuning of tolerances and solver parameters is generally needed. Moreover, QP solvers may need the problem to satisfy certain properties, for example positive definiteness of the unconstrained Hessian, which may not hold at a distance from the optimum.

In some embodiments, a solution strategy may exploit the recursive structure of the problem: e.g., the Hessian of the Lagrangian is a banded matrix, more specifically a tridiagonal block matrix because constraints depend on two consecutive time steps only; and the blocks themselves are sparse.

An alternative strategy enabled by this recursive structure is the use of dynamic programming. This strategy is less restrictive when it comes to properties, and provides a direct solution strategy instead of an iterative one, without requiring explicit assembly of the system matrix. In some embodiments, this strategy outperforms a sparse solution strategy on the full system in terms of robustness and speed.

To apply dynamic programming, the system 100 may first bring the above QP into standard form for a linear discrete-time optimal control problem as shown below.

$${min}_{{\tilde{s}}_{k} , {\tilde{u}}_{k}} {\sum }_{k = 0}^{n - 1} {[ \begin{matrix}{\tilde{s}}_{k} \\ {\tilde{u}}_{k}\end{matrix} ]}^{T} [ \begin{matrix}{\tilde{Q}}_{k} & {\tilde{S}}_{k}^{T} \\ {\tilde{S}}_{k} & {\tilde{R}}_{k}\end{matrix} ] [ \begin{matrix}{\tilde{s}}_{k} \\ {\tilde{u}}_{k}\end{matrix} ] + {\tilde{s}}_{n}^{T} {\tilde{P}}_{n} {\tilde{s}}_{n} \qquad ( Eq . 7 )$$

$$s . t . {\tilde{s}}_{k + 1} = {Ã}_{k} {\tilde{s}}_{k} + {\tilde{B}}_{k} {\tilde{u}}_{k} ,$$

$$k = 0 , … , n - 1.$$

In this standard form, the “state” and “control” variables are \tilde{s}ₖ and ũₖ. The QP can then be solved with dynamic programming by the system 100.

Solving a QP for a linear discrete-time optimal control problem with dynamic programming. The initial state (or conditions) are assumed to be known. See, e.g., Table 2.

TABLE 2

| | |
|---|---|
| 0. | Set \tilde{s}₀ to a constant value. |
| 1. | Evaluate \tilde{P}ₙ. |
| 2. | Solve for \tilde{P}ₖ backward in time, k = n − 1, . . . , 0: |
| | \tilde{P}ₖ := \tilde{Q}ₖ + Ãₖ^{T}\tilde{P}ₖ₊₁Ãₖ − |
| | (\tilde{S}ₖ^{T} + Ãₖ^{T}\tilde{P}ₖ₊₁\tilde{B}ₖ)(\tilde{R}ₖ + \tilde{B}ₖ^{T}\tilde{P}ₖ₊₁\tilde{B}ₖ)⁻¹ (\tilde{S}ₖ + \tilde{B}ₖ^{T}\tilde{P}ₖ₊₁Ãₖ) |
| 3. | Solve for ũₖ and \tilde{s}ₖ₊₁ forward in time, k = 0, . . . , n − 1: |
| | ũₖ(\tilde{s}ₖ) := −(\tilde{R}ₖ + \tilde{B}ₖ^{T}\tilde{P}ₖ₊₁\tilde{B}ₖ)⁻¹ (\tilde{S}ₖ + \tilde{B}ₖ^{T}\tilde{P}ₖ₊₁Ãₖ)\tilde{s}ₖ |
| | \tilde{s}ₖ₊₁ = Ãₖ\tilde{s}ₖ + \tilde{B}ₖũₖ(\tilde{s}ₖ) |

In the step-by-step derivation that follows, the system 100 may reduce the QP to this standard form, defining the matrices in the above standard equations.

The linearized design and control constraints may depend on two consecutive time steps and can be brought into standard form. In some embodiments, the design constraints depend on Δpₖ and Δpₖ₊₁. Analogously, in some embodiments, the velocity constraints depend on the control parameters at k and k+1, but only on velocity variables at k. In some embodiments, the design and control variables may be state variables in the standard form, and the velocity variables take on the role of control variables

$${\tilde{s}}_{k} := [ \begin{matrix}1 \\ Δ {p}_{k} \\ Δ {u}_{k}\end{matrix} ] \qquad ( Eq . 8 )$$

$$and$$

$${\tilde{u}}_{k} := Δ {v}_{k} .$$

In some embodiments, the system 100 may add a leading 1 in the definition of states, allowing the system 100 to combine the gradient and Hessian of the Lagrangian at k into a single quadratic form as desired.

In some embodiments, the state variables Δsₖ in the above definition of \tilde{s}ₖ and ũₖ may be omitted. They may appear in the linearized kinematic constraints that determine their values for a given Δpₖ and Δuₖ.

$${c}_{k} = - {( {C}_{s}^{k} )}^{- 1} {C}^{k} \qquad ( Eq . 9 )$$

$$Δ {s}_{k} = {c}_{k} + {P}_{k} Δ {p}_{k} + {U}_{k} Δ {u}_{k} {P}_{k} = - {( {C}_{s}^{k} )}^{- 1} {C}_{p}^{k}$$

$${U}_{k} = - {( {C}_{s}^{k} )}^{- 1} {C}_{u}^{k}$$

where redundant constraints were removed from C and the Jacobian Cₛ^{k} is a square matrix. By substituting Eq. 9 for Δsₖ in the individual Lagrangian terms [symbol] ^{k}, the system 100 can remove these variables and the kinematic constraints.

In some embodiments, the unit length constraints for the design parameters at k=0. By forming a singular value decomposition of the Jacobian [symbol] ₚ⁰, the system 100 can represent the solutions that satisfy the constraint with a reduced set of variables Δp̅₀

$$Δ {p}_{0} = {y}_{0}^{𝒫} + {Z}_{0}^{𝒫} Δ {\overline{p}}_{0} \qquad ( Eq . 10 )$$

$$with spec . sol .$$

$${y}_{0}^{𝒫} = - {{Y}_{0}^{𝒫} ( {𝒫}_{p}^{0} {Y}_{0}^{𝒫} )}^{- 1} {𝒫}^{0} ,$$

where [ [symbol] | [symbol] ] are the right singular vectors, with [symbol] corresponding to non-zero singular values. For the control parameters at k=0, the system 100 can proceed analogously. The reduced variables may be incorporated in an algorithm herein by adding the equation \tilde{s}₀:=Ã₋₁\tilde{s}₋₁, with

$${Ã}_{- 1} := [ \begin{matrix}1 & 0 & 0 \\ {y}_{0}^{𝒫} & {Z}_{0}^{𝒫} & 0 \\ {y}_{0}^{𝒰} & 0 & {Z}_{0}^{𝒰}\end{matrix} ] \qquad ( Eq . 11 )$$

$$and$$

$${\tilde{s}}_{- 1} := [ \begin{matrix}1 \\ Δ {\tilde{p}}_{0} \\ Δ {\tilde{u}}_{0}\end{matrix} ]$$

for k=−1 to the set of constraints. Ã₋₁ represents a mapping from reduced to full space. Note that \tilde{s}₋₁ represents design and control variables at k=0 in reduced space, while \tilde{s}₀ represents them in full space.

The remaining unit quaternion constraints for k=1, . . . , n are less straightforward to remove. To do so, the velocity and unit quaternion constraints for control parameters may be considered together, rearranging terms to align time steps

$$Δ {u}_{k + 1} = Δ {u}_{k} + Δ t Δ {v}_{k} - ( {u}_{k + 1} - {u}_{k} - Δ {tv}_{k} ) \qquad ( Eq . 11 )$$

$${𝒰}_{u}^{k + 1} Δ {u}_{k + 1} = - {𝒰}^{k + 1} ,$$

$$k = 0 , … , n - 1.$$

A projection of control parameters onto a reduced set, Δũₖ₊₁, as above for k=0 may not lead to a solution, because the matrix [symbol] for a singular value decomposition of the Jacobian [symbol] ᵤ^{k+1} would appear in front of a reduced set of control parameters Δũₖ₊₁, and cannot be brought to the other side because it is not a square matrix and hence not invertible.

An alternative is to work with reduced velocity variables. To this end, the system 100 substitutes the velocity equations for uₖ₊₁ in the second equation

$${𝒰}_{u}^{k + 1} Δ {v}_{k} = - \frac{1}{Δ t} {𝒰}_{u}^{k + 1} Δ {u}_{k} - {V}^{k} \qquad ( Eq . 12 )$$

$${V}^{k} := \frac{1}{Δ t} ( {𝒰}_{}^{k + 1} + {𝒰}_{u}^{k + 1} ( {u}_{k} - {u}_{k + 1} + Δ {tv}_{k} ) ) ,$$

then represent the solutions with a reduced set Δ [symbol] ₖ

$$Δ {v}_{k} = {y}_{k + 1}^{𝒰} + {X}_{k + 1}^{𝒰} Δ {u}_{k} + {Z}_{k + 1}^{𝒰} Δ {\overline{v}}_{k} \qquad ( Eq . 13 )$$

$$with$$

$${X}_{k + 1}^{𝒰} = - \frac{1}{Δ t} {{Y}_{k + 1}^{𝒰} ( {𝒰}_{u}^{k + 1} {Y}_{k + 1}^{𝒰} )}^{- 1} {𝒰}_{u}^{k + 1}$$

$$and$$

$${y}_{k + 1}^{𝒰} = - {{Y}_{k + 1}^{𝒰} ( {𝒰}_{u}^{k + 1} {Y}_{k + 1}^{𝒰} )}^{- 1} {V}^{k} .$$

The subspace velocity equations then become

$$( Eq . 14 )$$

$$Δ {u}_{k + 1} = ( I + Δ t {X}_{k + 1}^{𝒰} ) Δ {u}_{k} + ( Δ t {Z}_{k + 1}^{𝒰} ) Δ {\overline{v}}_{k} - Δ {ty}_{k + 1}^{𝒰} + ( {u}_{k + 1} - {u}_{k} - Δ {tv}_{k} ) .$$

Note that the system 100 may use reduced velocity variables Δv̅ₖ instead of Δvₖ in control variables ũₖ for time steps k.

In some embodiments, an optimization algorithm and matrices \tilde{Q}ₖ, \tilde{S}ₖ, \tilde{R}ₖ, \tilde{P}ₙ, Ãₖ, and \tilde{B}ₖ are summarized below. The system 100 may solve for the state \tilde{s}₋₁ by minimizing the objective \tilde{s}^{T}\tilde{P}₋₁\tilde{s}. Taking into account the leading 1 in the state representation, the minimization reduces to a linear system of equations

$$( Eq . 15 )$$

$${{min}_{\tilde{s}} [ \begin{matrix}1 \\ Δ \overline{p} \\ Δ \overline{u}\end{matrix} ]}^{T} {\tilde{P}}_{- 1} [ \begin{matrix}1 \\ Δ \overline{p} \\ Δ \overline{u}\end{matrix} ]$$

$$with$$

$${\tilde{P}}_{- 1} := [ \begin{matrix}0 & {\tilde{p}}_{p}^{T} & {\tilde{p}}_{u}^{T} \\ {\tilde{p}}_{p} & {\tilde{P}}_{pp} & {\tilde{P}}_{pu} \\ {\tilde{p}}_{u} & {\tilde{P}}_{pu}^{T} & {\tilde{P}}_{uu}\end{matrix} ] ⇔ {\tilde{s}}_{- 1} := {[ \begin{matrix}{\tilde{P}}_{pp} & {\tilde{P}}_{pu} \\ {\tilde{P}}_{pu}^{T} & {\tilde{P}}_{uu}\end{matrix} ]}^{- 1} [ \begin{matrix}{\tilde{p}}_{p} \\ {\tilde{p}}_{u}\end{matrix} ] .$$

TABLE 3
One example of a programming algorithm for
determining a kinematic design of a robotic device.

| | |
|---|---|
| 1. | Evaluate \tilde{P}ₙ. |
| 2. | Solve for \tilde{P}ₖ backward in time, k = n − 1, . . . , 0: |
| | \tilde{P}ₖ := \tilde{Q}ₖ + Ãₖ^{T}\tilde{P}ₖ₊₁Ãₖ − |
| | (\tilde{S}ₖ^{T} + Ãₖ^{T}\tilde{P}ₖ₊₁\tilde{B}ₖ)(\tilde{R}ₖ + \tilde{B}ₖ^{T}\tilde{P}ₖ₊₁\tilde{B}ₖ)⁻¹ (\tilde{S}ₖ + \tilde{B}ₖ^{T}\tilde{P}ₖ₊₁Ãₖ |
| 3. | Evaluate \tilde{P}₋₁ := Ã₋₁^{T}\tilde{P}₀Ã₋₁ |
| 4. | Evaluate \tilde{s}₋₁ := [symbol] \tilde{s}^{T}\tilde{P}₋₁\tilde{s} |
| 5. | Evaluate \tilde{s}₀ := Ã₋₁\tilde{s}₋₁ |
| 6. | Solve for \tilde{s}ₖ and ũₖ forward in time, k = 0, . . . , n − 1: |
| | ũₖ(\tilde{s}ₖ) := −(\tilde{R}ₖ + \tilde{B}ₖ^{T}\tilde{P}ₖ₊₁\tilde{B}ₖ)⁻¹ (\tilde{S}ₖ + \tilde{B}ₖ^{T}\tilde{P}ₖ₊₁Ãₖ)\tilde{s}ₖ |
| | \tilde{s}ₖ₊₁ = Ãₖ\tilde{s}ₖ + \tilde{B}ₖũₖ(\tilde{s}ₖ) |

```
TABLE 4
Definition of \tilde{Q}ₖ, \tilde{S}ₖ, \tilde{R}ₖ, \tilde{P}ₙ, Ãₖ, and \tilde{B}ₖ matrices. To keep the notation
concise, we omit the index k in derivatives of the Lagrangian and for
matrices P, U, and c. For matrices X, Z, y, omit the index k + 1 and the
superscript [symbol]  .
matrices
  ${\tilde{Q}}_{k} = [ [ \begin{matrix}0 & \tilde{q} {}_{p}^{{}_{} T} & \tilde{q} {}_{u}^{{}_{} T} \\ {\tilde{q}}_{p} & {\tilde{Q}}_{pp} & {\tilde{Q}}_{pu} \\ {\tilde{q}}_{u} & \tilde{Q} {}_{pu}^{{}_{} T} & {\tilde{Q}}_{uu}\end{matrix} ] ] {\tilde{S}}_{k} = [ \begin{matrix}{\tilde{s}}_{v} & {\tilde{S}}_{pv}^{T} & {\tilde{S}}_{pu}^{T} ] {\tilde{R}}_{k}\end{matrix}$
  ${\tilde{P}}_{n} = [ \begin{matrix}0 & \tilde{p} {}_{p}^{{}_{} T} & \tilde{p} {}_{u}^{{}_{} T} \\ {\tilde{p}}_{p} & {\tilde{P}}_{pp} & {\tilde{P}}_{pu} \\ {\tilde{p}}_{u} & \tilde{P} {}_{pu}^{{}_{} T} & {\tilde{P}}_{uu}\end{matrix} ] {\tilde{A}}_{k} = [ \begin{matrix}1 & 0 & 0 \\ {\tilde{a}}_{p} & {\tilde{A}}_{pp} & 0 \\ {\tilde{a}}_{u} & 0 & {\tilde{A}}_{uu}\end{matrix} ] {\tilde{B}}_{k} = [ \begin{matrix}0 \\ 0 \\ {\tilde{b}}_{u}\end{matrix} ]$
  matrix entries
  \tilde{q}ₚ := ( [symbol]  ₚₛ + P^{T} [symbol] ₛₛ)c + ( [symbol]  ₚᵥ + P^{T} [symbol]  ₛᵥ)y + [symbol]  ₚ + P^{T} [symbol]  ₛ
  \tilde{q}ᵤ := ( [symbol] ᵤₛ + U^{T} [symbol]  ₛₛ) c + ( [symbol]  ᵤᵥ + U^{T} [symbol]  ₛᵥ)y + X^{T} ( [symbol]  ᵥₛc + [symbol]
      ᵥᵥy) + [symbol]  ᵤ + U^{T} [symbol]  ₛ + X^{T} [symbol]  ᵥ
  \tilde{Q}ₚₚ := [symbol] ₚₚ + [symbol]  ₚₛP + P^{T} [symbol]  ₛₛP
  \tilde{Q}ₚᵤ := [symbol] ₚᵤ + [symbol]  ₚₛU + P^{T} [symbol]  ₛᵤ + P^{T} [symbol]  ₛₛU + ( [symbol]  ₚᵥ + P^{T} [symbol] ₛᵥ)X
  \tilde{Q}ᵤᵤ := [symbol] ᵤᵤ + [symbol]  ᵤₛU + U^{T} [symbol] ₛᵤ + U^{T} [symbol] ₛₛU + ( [symbol]  ᵤᵥ + U^{T} [symbol] ₛᵥ)X +
    X^{T}( [symbol] ᵥᵤ + [symbol] ᵥₛU) + X^{T} [symbol] ᵥᵥX
  \tilde{s}ᵥ := Z^{T}( [symbol]  ᵥₛc + [symbol]  ᵥᵥy + [symbol]  ᵥ)
  \tilde{S}ₚᵥ := ( [symbol]  ₚᵥ + P^{T} [symbol]  ₛᵥ) Z
  \tilde{S}ᵤᵥ := ( [symbol]  ᵤᵥ + U^{T} [symbol] _{sy} + X^{T} [symbol] _{yy})Z
  \tilde{R}ₖ := Z^{T} [symbol] _{yy}Z
  \tilde{p}ₚ := ( [symbol]  ₚₛ + P^{T} [symbol]  ₛₛ)c + [symbol]  ₚ + P^{T} [symbol]  ₛ
  \tilde{p}ᵤ := ( [symbol]  ᵤₛ + U^{T} [symbol]  ₛₛ)c + [symbol]  ᵤ + U^{T} [symbol]  ₛ
  \tilde{P}ₚₚ := [symbol]  ₚₚ + [symbol]  ₚₛP + P^{T} [symbol]  ₛₚ + P^{T} [symbol]  ₛₛP
  \tilde{P}ₚᵤ := [symbol]  ₚᵤ + [symbol]  ₚₛU + P^{T} [symbol]  ₛᵤ + P^{T} [symbol]  ₛₛU
  \tilde{P}ᵤᵤ := [symbol]  ᵤᵤ + [symbol]  ᵤₛU + U^{T} [symbol]  ₛᵤ + U^{T} [symbol]  ₛₛU
  ãₚ := pₖ − pₖ₊₁
  ãᵤ := Δty + (uₖ + Δtvₖ − uₖ₊₁)
  Ãₚₚ := I
  Ãᵤᵤ := I + Δt X
  \tilde{b}ᵤ := Δt Z
```

The output of equation 11 may be one or more search directions, dₖ, for optimization variables, which may be identical to the ones obtained by solving the equivalent QP. To compute a corresponding search direction, Δλ, for the Lagrange multipliers, the system 100 expands the first equation of the Karush-Kuhn-Tucker system that is equivalent to the QP, solving for the individual multiplier increments by utilizing the recursive structure as summarized herein. The system 100 may then perform the update of the current best multiplier estimates

$$[ \begin{matrix}{λ}_{k}^{𝒟} \\ {λ}_{k}^{V} \\ {λ}_{k}^{𝒰} \\ {λ}_{k}^{𝒞}\end{matrix} ] := [ \begin{matrix}{λ}_{k}^{𝒟} \\ {λ}_{k}^{V} \\ {λ}_{k}^{𝒰} \\ {λ}_{k}^{𝒞}\end{matrix} ] + α [ \begin{matrix}Δ {λ}_{k}^{𝒟} \\ Δ {λ}_{k}^{V} \\ Δ {λ}_{k}^{𝒰} \\ Δ {λ}_{k}^{𝒞}\end{matrix} ]$$

$$for$$

$$k = 1 , … , n - 1 ,$$

$$and$$

$$[ \begin{matrix}{λ}_{0}^{𝒟} \\ {λ}_{0}^{V} \\ {λ}_{0}^{𝒫} \\ {λ}_{0}^{𝒰} \\ {λ}_{0}^{𝒞}\end{matrix} ] := [ \begin{matrix}{λ}_{0}^{𝒟} \\ {λ}_{0}^{V} \\ {λ}_{0}^{𝒫} \\ {λ}_{0}^{𝒰} \\ {λ}_{0}^{𝒞}\end{matrix} ] + α [ \begin{matrix}Δ {λ}_{0}^{𝒟} \\ Δ {λ}_{0}^{V} \\ Δ {λ}_{0}^{𝒫} \\ Δ {λ}_{0}^{𝒰} \\ Δ {λ}_{0}^{𝒞}\end{matrix} ] ,$$

$$[ \begin{matrix}{λ}_{n}^{𝒰} \\ {λ}_{n}^{𝒞}\end{matrix} ] := [ \begin{matrix}{λ}_{n}^{𝒰} \\ {λ}_{n}^{𝒞}\end{matrix} ] + α [ \begin{matrix}{Δλ}_{n}^{𝒰} \\ Δ {λ}_{n}^{𝒞}\end{matrix} ]$$

for the first and last time steps, with the step length α.

Solving for Lagrange multiplier increments.

| | |
|---|---|
| 1. | Compute hₚ^{k}, hᵤ^{k}, hₛ^{k}, k = 0, . . . , n and hᵥ^{k}, k = 0, . . . , n − 1: |
| | hₚ^{k} := [symbol] ₚₚ^{k}Δpₖ + [symbol] ₚᵤ^{k}Δuₖ + [symbol] ₚᵥ^{k}Δvₖ + [symbol] ₚₛ^{k}Δsₖ + [symbol] ₚ^{k}, k < n |
| | hₚⁿ := [symbol] ₚₚⁿΔpₙ + [symbol] ₚᵤⁿΔuₙ + λₚₛⁿΔsₙ + [symbol] ₚⁿ |
| | hᵤ^{k} := [symbol] ᵤₚ^{k}Δpₖ + [symbol] ᵤᵤ^{k}Δuₖ + [symbol] ᵤᵥ^{k}Δvₖ + [symbol] ᵤₛ^{k}Δsₖ + [symbol] ᵤ^{k}, k < n |
| | hᵤⁿ := [symbol] ᵤₚⁿΔpₙ + [symbol] ᵤᵤⁿΔuₙ + λᵤₛⁿΔsₙ + [symbol] ᵤⁿ |
| | hᵥ^{k} := [symbol] ᵥₚ^{k}Δpₖ + [symbol] ᵥᵤ^{k}Δuₖ + [symbol] ᵥᵥ^{k}Δvₖ + [symbol] ᵥₛ^{k}Δsₖ + [symbol] ᵥ^{k}, k < n |
| | hₛ^{k} := [symbol] ₛₚ^{k}Δpₖ + [symbol] ₛᵤ^{k}Δuₖ + [symbol] ₛᵥ^{k}Δvₖ + [symbol] ₛₛ^{k}Δsₖ + [symbol] ₛ^{k}, k < n |
| | hₛⁿ := [symbol] ₛₚⁿΔpₙ + [symbol] ₛᵤⁿΔuₙ + [symbol] ₛₛⁿΔsₙ + [symbol] ₛⁿ |
| 2. | $Compute Δ {λ}_{k}^{𝒱} = - \frac{1}{Δ {}_{} t} {h}_{v}^{{}_{} k} , k = 0 , … , n - 1$ |
| 3. | Compute [symbol] = ( [symbol] ₛ^{k})^{-T}hₛ^{k}, k = 0, . . . , n. |
| 4. | Solve for [symbol] backward in time, k = n − 1, . . . ,0: |
| | [symbol] = hₚⁿ − ( [symbol] ₚⁿ)^{T} [symbol] |
| | [symbol] = hₚ^{k+1} − ( [symbol] ₚ^{k+1})^{T} [symbol] + [symbol] |
| 5. | Compute [symbol] , k = 0, . . . , n: |
| | [symbol] = ( [symbol] ᵤ^{k}( [symbol] ᵤ^{k})^{T})⁻¹ [symbol] ᵤ^{k}(hᵤ^{k} − ( [symbol] ᵤ^{k})^{T} [symbol] + |
| | Δλₖ^{V} − [symbol] ) |
| 6. | Solve for [symbol] = ( [symbol] ₚ⁰( [symbol] ₚ⁰)^{T})⁻¹ [symbol] ₚ⁰(hₚ⁰ − ( [symbol] ₚ⁰)^{T} [symbol] + |
| | [symbol] ) |

Robotic devices with kinematic loops often have redundancy in constraints. For example, linkages are used to place actuators where there is space, while they provide the source of motion where it is needed. Linkages introduce redundancy. A simple case to see this is a four bar linkage (e.g., as shown in FIG. 2A-FIG. 2C): because the linkage has four components, the linkage has a total of 28 state variables. The unit length constraints reduce this to 24 degrees of freedom. The linkage is driven by a revolute actuator (6 constraints), has three revolute joints (3×5=15 constraints), and one component may be constrained to the ground (6 constraints). Therefore the linkage has a 24 dimensional state and a total of 27 constraints. Even though the linkage has a minimal number of constraints when considering the degrees of freedom of individual joints and actuators, there may be more constraints than unknown states for general robotic characters with kinematic loops. Because linkages are only one source of redundancy in [symbol] , a general solution may help remove unnecessary constraints.

In some embodiments, the constraint elimination process takes as input a reference state s of the robotic device (e.g., its initial design configuration or first frame of an animation), and automatically selects a non-redundant subset of constraints in [symbol] so that this subset contains as many constraints as unknown states in s. Because the behavior in a neighborhood of s may be considered to choose the “right” subset, the system 100 may rely on the Jacobian [symbol] s. However, before the system 100 computes the Jacobian, the system 100 may remove all actuators, replacing them with corresponding passive joints. This computation may be used because actuators, for a particular set of control parameters u, hold the robot in the state s. The system 100 would therefore not see the “mobility” of the robot in a neighborhood of s if the system 100 analyzed the Jacobian of the actuated system directly. If the system 100 analyzed the Jacobian corresponding to the passive system, however, the mobility of mechanical joints and actuators. Before analyzing the Jacobian, [symbol] s, of the passive system, the system 100 may normalize each row. Each of its rows i can be understood as a direction in which the kinematic structure is immobile, while the mobility of the passive system is spanned by directions that are not part of the space that the rows span. The goal is therefore to keep the constraints so that the corresponding rows span the space with an as orthogonal basis as possible, preventing the introduction of any unwanted mobility. This motivates the following selection process: first form the singular value decomposition of [symbol] s, and extract the left singular vectors Z that correspond to zero singular values, such that Z^{T} [symbol] ₛ=0. Each row k of these equations provide a linear combination that evaluates to zero

$${\sum }_{i} {{z}_{ik} ( {𝒞}_{s} )}_{i} = 0 , \qquad ( Eq . 16 )$$

where ( [symbol] ₛ)ᵢ refers to row of the Jacobian. For any j such that zⱼₖ≠0, where equation in Eq. 16 may eliminate constraint that is already in the span of the other constraints

$${( {𝒞}_{s} )}_{j} = - {\sum }_{i \neq j} \frac{{z}_{ik}}{{z}_{jk}} {( {𝒞}_{s} )}_{i} . \qquad ( Eq . 17 )$$

To reduce of prevent unwanted mobility, j may be set so that the constraint that is the “least” orthogonal to others is removed, or that results in the lowest right-hand-side coefficients in Eq. 16

$$j = arg {min}_{j} {min}_{k} {\sum }_{i \neq j} \frac{{z}_{ik}^{2}}{{z}_{jk}^{2}} . \qquad ( Eq . 18 )$$

The rows of the Jacobian may be normalized to make the coefficients comparable. After adding j to the set of eliminated constraints, the corresponding equation may be removed k, and subtracted from the remaining equations

$${z}_{: i} := {z}_{: i} - \frac{{z}_{ji}}{{z}_{jk}} {z}_{: k} , \qquad ( Eq . 19 )$$

setting coefficients zᵢⱼ to zero that correspond to the eliminated constraint j. The system 100 may iterate the process until all equations from Eq. 16 have been used. The Jacobian of the subset of selected constraints has full row rank, and if the additional constraints are added back full rank Jacobian for the actuated system may result. In some embodiments, an exception is an over-actuated robot with more actuators than needed for its degrees of freedom. For over-actuated robots, after removing redundancy in the passive Jacobian, the process may be repeated, but using the Jacobian of the actuated system with passive redundancy removed and considering only actuation constraints for elimination.

When editing the design of an existing robotic device, the system 100 may first simulate its kinematic motion and then record trajectories of points of interest. By representing them with spatial cubic Hermite splines, or applying transformations to them, the system 100 can then edit the target motion, and therefore the design of the robotic device. If a user designs a robotic device from scratch, a rigged character can serve as a conceptual input, or motion capture could serve as a source of motion input.

Independent of the use case, the system 100 may track the difference between the motion of points of interest on the robotic device and user-provided target motion. To this end, the system 100 may use tracking objectives.

In a local coordinate frame of a rigid body that may be guided based on a target animation, the system 100 may define the position x_{rb} and/or orientation A_{rb}. The global motion over time of the position, x(sₖ), and orientation, A(sₖ), are then used to define tracking objectives based on the target positions, \hat{x}ₖ, and orientations, Âₖ (right).

To measure a robotic device's performance with respect to user-specified targets, the system 100 supports position and orientation tracking. A target trajectory either includes of a target point, \hat{x}ₖ, or a target orientation, \hat{R}ₖ, for every time step k, or a combination of the two. The system 100 chooses a position, x_{rb}, and/or orientation, A_{rb}, in a local coordinate frame of a rigid body whose motion the target trajectory guide. During optimization, the system 100 transforms the local position and orientation to global coordinates using the body's position cₖ and orientation qₖ

$$x ( {s}_{k} ) = R ( {q}_{k} ) {x}_{rb} + {c}_{k} \qquad ( Eq . 21 )$$

$$and$$

$$A ( {s}_{k} ) = R ( {q}_{k} ) {A}_{rb} ,$$

then measure differences with our position and orientation objectives

$${f}_{pos} ( {s}_{k} ) = \frac{1}{2} {‖ x ( {s}_{k} ) - \hat{x} ‖}_{W}^{2} \qquad ( Eq . 22 )$$

$$and$$

$${f}_{ori} ( {s}_{k} ) = \frac{1}{2} {w}_{ori} {‖ A ( {s}_{k} ) - {Â}_{k} ‖}^{2} ,$$

where a weighted norm W=diag(wₓ, w_{y}, w_{z}) is used for positions and weigh orientation objectives with wₒᵣᵢ. In some embodiments, these weights can be set to non-constant values to emphasize preservation of motion either spatially or temporally, or both. For points of interest, the system 100 may add position and/or orientation objectives to the intermediate and terminal objectives, f and F.

The system 100 supports position and velocity limits for actuators, and position limits for configurable joints. The system 100 enforces them with a smooth barrier function

$$β ( x , {x}_{max} , ε ) = \{ \begin{matrix}- log {( \frac{{x}_{max} - x}{ε} )}^{3} & if x \geq {x}_{max} - ε \\ 0 & otherwise ,\end{matrix} \qquad ( Eq . 23 )$$

that becomes active if a value x is less than an ε from either a user-specified lower or upper limit xₘᵢₙ or xₘₐₓ, resulting in our limits objective

$${f}_{lim} ( x ) = β ( - x , - {x}_{min} , ε ) + β ( x , {x}_{max} , ε ) . \qquad ( Eq . 24 )$$

For each component x of the control parameters, uₖ and vₖ, and the design parameters, pₖ, the system 100 adds a limits objective to the intermediate objective f. For the terminal objective F, the system 100 adds position limits.

To avoid ill-posed problems, the method may include regularization terms

$${f}_{reg}^{𝒰} ( {u}_{k} ) = \frac{1}{2} {w}_{reg}^{𝒰} {‖ {u}_{k} - {u}_{k}^{0} ‖}^{2} \qquad ( Eq . 25 )$$

$$and$$

$${f}_{reg}^{𝒫} ( {p}_{k} ) = \frac{1}{2} {w}_{reg}^{𝒫} {‖ {p}_{k} - {p}^{0} ‖}^{2} ,$$

keeping control parameters close to an initial animation, uₖ⁰, on the un-optimized design, and design parameters close to their initial values p⁰. For some examples, the null-space in design parameters can be large, requiring a higher weight for the [symbol] . This can have an effect on the quality of the result. To mitigate its impact, in some embodiments, the method may include updating p⁰ with design parameters from the last iterate in a decreasing frequency, i.e., at iterations 2, 4, 8, 16, etc., is effective, without a noticeable effect on convergence. The regularization terms are added to both f and F.

According to some examples, the method 600 includes deploying to a physical robotic device at operation 612. As shown for example in FIG. 7D, the optimized design configuration 504 may be realized in a real robotic device 112. For example, a robotic device 112 including configurable components may have those components configured according to the optimized design configuration 504 (e.g., as discussed with respect to the leg linkage 500).

For example, as shown in FIG. 7B-FIG. 7D between the initial design configuration 502 shown in FIG. 7B and the optimized design configuration 504 the hip joints, were reduced from three degrees-of-freedom in the initial design configuration 502 to two joints in the hips. For the shoulder, the initial design configuration 502 included 3-DoF input, whereas the optimized design configuration 504 includes a single joint. Similarly, at the elbows, the initial design configuration 502 includes a parameterized revolute joint, meaning that the elbows remain fixed over time but their angle can be optimized.

For the initial design configuration 502, the actuators may be naively oriented along one of the world axes (e.g., in the environment of the robotic device). Using the method 600 the orientations of the joints were parameterized, with the exception of the knees. The initial design configuration 502 poorly tracks the target animation 702. However, in the optimized design configuration 504, the robotic device is able to track the initial design configuration 502 well, despite the reduced number of actuators. In some embodiments, a velocity limit is introduced to the design (e.g., to better align with real-world velocities). Unlike previous approaches, the systems and methods of the present disclosure, account for a full motion sequence and therefore track a target animation 702 better than previous approaches.

FIG. 8 is a simplified block diagram of components of a computing system 800 of the system 100, such as the server 108, the user device 104, the user robotic device 112, etc. For example, the processing clement 802 and the memory component 808 may be located at one or in several computing systems 800. This disclosure contemplates any suitable number of such computing systems 800. For example, the server 108 may be a desktop computing system, a mainframe, a blade, a mesh of computing systems 800, a laptop or notebook computing system 800, a tablet computing system 800, an embedded computing system 800, a system-on-chip, a single-board computing system 800, or a combination of two or more of these. Where appropriate, a computing system 800 may include one or more computing systems 800; be unitary or distributed; span multiple locations; span multiple machines; span multiple data centers; or reside in a cloud, which may include one or more cloud components in one or more networks. A computing system 800 may include one or more processing elements 802, an input/output I/O interface 804, one or more external devices 812, one or more memory components 608, and a network interface 810. Each of the various components may be in communication with one another through one or more buses or communication networks, such as wired or wireless networks, e.g., the network 106. The components in FIG. 8 are exemplary only. In various examples, the computing system 800 may include additional components and/or functionality not shown in FIG. 8.

The processing element 802 may be any type of electronic device capable of processing, receiving, and/or transmitting instructions. For example, the processing element 802 may be a central processing unit, microprocessor, processor, or microcontroller. Additionally, it should be noted that some components of the computing system 800 may be controlled by a first processing element 802 and other components may be controlled by a second processing element 802, where the first and second processing elements may or may not be in communication with each other.

The I/O interface 804 allows a user to enter data in to computing system 800, as well as provides an input/output for the computing system 800 to communicate with other devices or services. The I/O interface 804 can include one or more input buttons, touch pads, touch screens, and so on.

The external device 812 are one or more devices that can be used to provide various inputs to the computing systems 600, e.g., mouse, microphone, keyboard, trackpad, sensing element (e.g., a thermistor, humidity sensor, light detector, etc. The external devices 812 may be local or remote and may vary as desired. In some examples, the external devices 812 may also include one or more additional sensors.

The memory components 808 are used by the computing system 800 to store instructions for the processing element 802 such as the initial design configuration 312, the initial design configuration 502, the optimized design configuration 504, component models, geometry, parameters, instructions that perform the operations of the method 600, and/or a user interface, user preferences, alerts, etc. The memory components 808 may be, for example, magneto-optical storage, read-only memory, random access memory, erasable programmable memory, flash memory, or a combination of one or more types of memory components.

The network interface 810 provides communication to and from the computing system 800 to other devices. The network interface 810 includes one or more communication protocols, such as, but not limited to Wi-Fi, Ethernet, Bluetooth, etc. The network interface 810 may also include one or more hardwired components, such as a Universal Serial Bus (USB) cable, or the like. The configuration of the network interface 810 depends on the types of communication desired and may be modified to communicate via Wi-Fi, Bluetooth, etc.

The display 806 provides a visual output for the computing system 800 and may be varied as needed based on the device. The display 806 may be configured to provide visual feedback to the user 102 and may include a liquid crystal display screen, light emitting diode screen, plasma screen, or the like. In some examples, the display 806 may be configured to act as an input element for the user 102 through touch feedback or the like.

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present disclosure and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

All relative, directional, and ordinal references (including top, bottom, side, front, rear, first, second, third, and so forth) are given by way of example to aid the reader's understanding of the examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A computer-implemented method for designing a robotic device, comprising a processor and a memory storing instructions that, when executed by the processor, cause the system to:
receive a target animation for a character to be represented by the robotic device;
receive an initial model of the robotic device, the model comprising a plurality of configurable joints and a plurality of actuators;
generate a kinematic design of the robotic device based on the initial model and the target animation;
generate control parameters for the plurality of actuators based on the kinematic design;
generate a physical design for the robotic device based on the kinematic design and the control parameters; and
deploy the physical design to the robotic device.

2. The computer-implemented method of claim 1, wherein the plurality of configurable joints include respective parameterized characteristics fixed during an animation of the robotic device.

3. The computer-implemented method of claim 1, wherein the instructions, when executed by the processor cause the processor to parameterize a characteristic of at least one of the plurality of configurable joints.

4. The computer-implemented method of claim 1, wherein the plurality of configurable joints comprises at least one of a Cartesian joint, a prismatic joint, a cylindrical joint, a revolute joint, a universal joint, or a spherical joint.

5. The computer-implemented method of claim 1, wherein the plurality of configurable joints comprises at least one of an actuated joint or a passive joint.

6. The computer-implemented method of claim 2, wherein the parameterized characteristics comprise at least one of an orientation or position of at least one of the plurality of configurable joints.

7. The computer-implemented method of claim 1, wherein the instructions, when executed by the processor cause the processor to discretize the target animation into a plurality of time intervals.

8. The computer-implemented method of claim 7, wherein the instructions, when executed by the processor cause the processor to compare a motion of the robotic device with respect to the target animation at each of the plurality of time intervals, and adjust the kinematic design based on the comparison.

9. The computer-implemented method of claim 8, wherein comparing the motion of the robotic device comprises measuring at least one of a position of at least one of the plurality of actuators or a velocity of at least one of the plurality of actuators.

10. A system for designing a robotic device, comprising a processor configured to:
receive a target animation for a character to be represented by the robotic device;
receive an initial model of the robotic device, the model comprising a plurality of configurable joints and a plurality of actuators;
generate a kinematic design of the robotic device based on the initial model and the target animation;
generate control parameters for the plurality of actuators based on the kinematic design;
generate a physical design for the robotic device based on the kinematic design and the control parameters; and
deploy the physical design to the robotic device.

11. The system of claim 10, wherein the plurality of configurable joints include respective parameterized characteristics fixed during an animation of the robotic device.

12. The system of claim 10, wherein the processor is further configured to parameterize a characteristic of at least one of the plurality of configurable joints.

13. The system of claim 10, wherein the plurality of configurable joints comprises at least one of a Cartesian joint, a prismatic joint, a cylindrical joint, a revolute joint, a universal joint, or a spherical joint.

14. The system of claim 10, wherein the plurality of configurable joints comprises at least one of an actuated joint or a passive joint.

15. The system of claim 11, wherein the parameterized characteristics of the plurality of configurable joints comprises at least one of an orientation or position of at least one of the plurality of configurable joints.

16. The system of claim 10, wherein the processor is further configured to discretize the target animation into a plurality of time intervals.

17. The system of claim 16, wherein the processor is further configured to compare a motion of the robotic device with respect to the target animation at each of the plurality of time intervals, and adjust the kinematic design based on the comparison.

18. The system of claim 17, wherein comparing the motion of the robotic device comprises measuring at least one of a position of at least one of the plurality of actuators or a velocity of at least one of the plurality of actuators.

19. A robotic device comprising:
a plurality of rigid bodies coupled together by one or more of a plurality of joints, wherein:
at least one of the plurality of joints is configurable to adjust a characteristic of the joint, and
the characteristic of the joint is fixed during an animation of the robotic device.

20. The robotic device of claim 19, wherein at least one of the plurality of joints comprises an actuated joint or a passive joint.
